(19) United States
(12) Patent Application Publication
(10) Pub. No.: US 2007/0014968 A1
(43) Pub. Date: Jan. 18, 2007

(54) COLLAPSIBLE SURFACE COVER

(75) Inventor: RALPH R. DUGGAN, Peoria, AZ (US)

Correspondence Address: GARY MALHOIT, 11409 N. 44TH COURT, PHOENIX, AZ, 85028, US

(73) Assignee: Ralph R. Duggan, Peoria, AZ (US)

(21) Appl. No.: 11/160,972

(22) Filed: Jul. 18, 2005

(51) Int. Cl. B32B 3/06

(52) U.S. Cl. 428/99

(57) ABSTRACT

A cover (100) for protecting a surface (3) such as a floor is expandable and collapsible for portability and includes a detachable layer (18). The detachable layer (18) is easily removed and serves as a collecting surface for solid objects such as food, scrap paper, art materials, and the like. The cover (100) can be made with a profile ranging from generally flat to generally concave or bowl shaped in relation to the surface (3). The concave profile of the cover (100) provides the ability for the cover (100) to contain liquids. In addition, a bottom of the cover (100) includes a gripping surface to reduce slippage between the cover (100) and the surface (3).

This invention generally relates to a surface cover for protecting a surface, and more particularly, to a collapsible surface cover that is portable and provides for easy removal of a top layer of the surface cover.

A number of tasks can result in unwanted materials such as food, shoe polish, paint, scrap and liquids contacting a surface such as a countertop, a table and a floor. The unwanted materials can damage the surface, which can include carpet, wood and grout. For example, the process of feeding a child generally results in food falling onto a portion of the floor below the feeding child. Cleaning the portion of the floor under the child typically is difficult, because of the adjacent table and chair legs. In addition, the cleaning process is considered drudge work and occurs generally with the same frequency as feeding the child.

In order to reduce the cleaning drudge work prior to feeding the child, a cover typically made of plastic is placed on the portion of the floor below where the child is fed. After feeding the child, the cover is simply removed from the floor, and the food on the collecting surface of the cover is disposed in a trash bin.

The cover can tend to shift or distribute unevenly forming folds on the cover's collecting top surface as a result of moving the cover or people treading on the cover. The resulting surface folds can provide a tripping hazard to an adult attending the feeding child. In addition, liquid spilled on the folded surface of the cover near the edge of the cover can flow onto the adjacent floor. Furthermore, removal and replacement of the cover to dispose of food or scrap collected on the cover generally can result in unintended repositioning of the cover. After unintentional repositioning, the cover may not collect food and scrap as desired. In addition, the cover tends to form creases when folded up and stored away such that when the cover is unfolded for use considerable time is required to press down the cover to reduce the folds.

Hence, there is a need for a cover that contains liquid and does not shift or form folds that are tripping hazards and does not unintentionally reposition on disposing of collected food or scrap.

### SUMMARY OF THE INVENTION

The present invention satisfies the foregoing need for a cover to protect a surface. In accordance with an embodiment of the invention, the cover is collapsible and comprises a first portion having first and second surfaces, and a spring-like member secured to the first portion to expand or collapse the first portion. At least one first fastener secures to the first surface. A second portion has at least one second fastener for receiving the at least one first fastener. The at least first and second fasteners engage and disengage to enable the first and second portions to quickly attach and detach, respectively.

In accordance with an embodiment of the invention, a cover that is collapsible is provided for protecting a surface. The collapsible cover includes a first portion having first and second surfaces. A spring-like member is secured to the first portion to expand or collapse the first portion. A second portion has third and fourth surfaces. At least one first and second fasteners are secured to the respective first and fourth surfaces of the first and fourth portions, respectively. The at least one first and second fastener engage to allow quick attachment or detachment between the first and second portions.

### BRIEF DESCRIPTION OF THE DRAWINGS

FIG. 1 is an exploded cross-section showing a cover in an expanded configuration;

FIG. 2 is a perspective view showing the cover in the expanded configuration;

FIG. 3 is a bottom perspective view showing the cover in the expanded configuration; and

FIG. 4 is an alternate embodiment of the invention showing an exploded cross-section of the cover in the expanded configuration.

### DETAILED DESCRIPTION OF THE DRAWINGS

Generally, the present invention provides a cover having an expanded and collapsed configuration used for protecting a surface and for transporting the cover, respectively. In accordance with one embodiment of the present invention, the cover includes a detachable top portion for connecting to or disconnecting from a bottom portion. The detachable top portion includes a surface used for collecting food or scrap materials. Without repositioning the bottom portion, the detachable top portion can be quickly removed. The detachable top portion and the bottom portion are conforming flexible layers and are generally parallel with respect to a generally flat surface. In another embodiment of the present invention, the conforming flexible layers are generally concave with respect to the generally flat surface allowing the cover to better contain liquids.

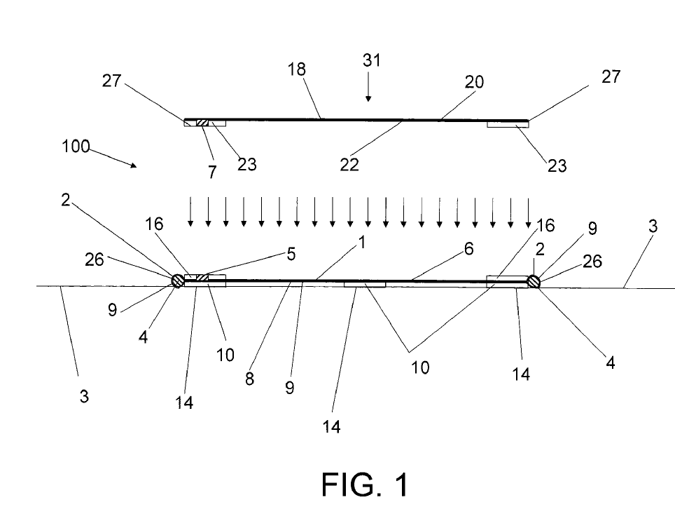

FIG. 1 is an exploded cross-section of a cover 100 in an expanded configuration comprising a base portion 1 positioned on a surface 3 and includes a detachable layer 18. The cover 100 can be used on any surface including a floor, a counter-top, a patio deck, and the like. The cover 100 can be used to protect the surface 3 or an item on the surface 3. The base portion 1 having top 6 and bottom 8 surfaces provides a barrier to liquids and can include a hem 2 for containing or securing a flexible hoop 4. The flexible hoop 4 can be made of materials having sufficient spring-like characteristics such as spring steel, spring plastic, and the like. The base portion 1 is flexible and comprises at least one sheet 9 of material including woven fabric, plastic, rubber, reinforced paper, plasticized metal foil, and the like. In an expanded configuration, the flexible hoop 4 applies an outward force to expand the base portion 1. The cover 100 converts to a collapse configuration by twisting the base portion 1. The flexible hoop 4 can secure to the base portion 1 using a number of techniques. For example, the flexible hoop 4 can be secured between two sheets of material by sewing or bonding using various adhesives. In addition, the flexible hoop 4 can be secured to the base portion 1 by forming the sheet 9 at the edge 26 into the hem 2 to contain the flexible hoop 4. The flexible hoop 4 can be secured to the base portion 1 and be able to fully expand without any limitation by the sheet 9 making up the base portion 1. In other words, the flexible hoop 4 provides an outward force that can extend the full limit of expansion of the sheet 9. Hence, with the base portion 1 positioned on the surface 3, the base portion 1 provides a profile that is substantially flat and is nearly parallel with respect to the surface 3. This provides the advantage of maintaining the profile of the cover 100 when the cover 100 is stepped on or moved. For example, by lifting, sliding and dropping the cover 100 on the surface 3, the cover 100 maintains its profile with respect to the generally flat surface 3. The cross-section of the flexible hoop 4 is shown as round. However, the cross-section of the flexible hoop 4 can include a number of shapes such as rectangular, triangular and the like. The cross-section and method of securing the flexible hoop 4 to the base portion 1 should not be considered a limitation of the present invention.

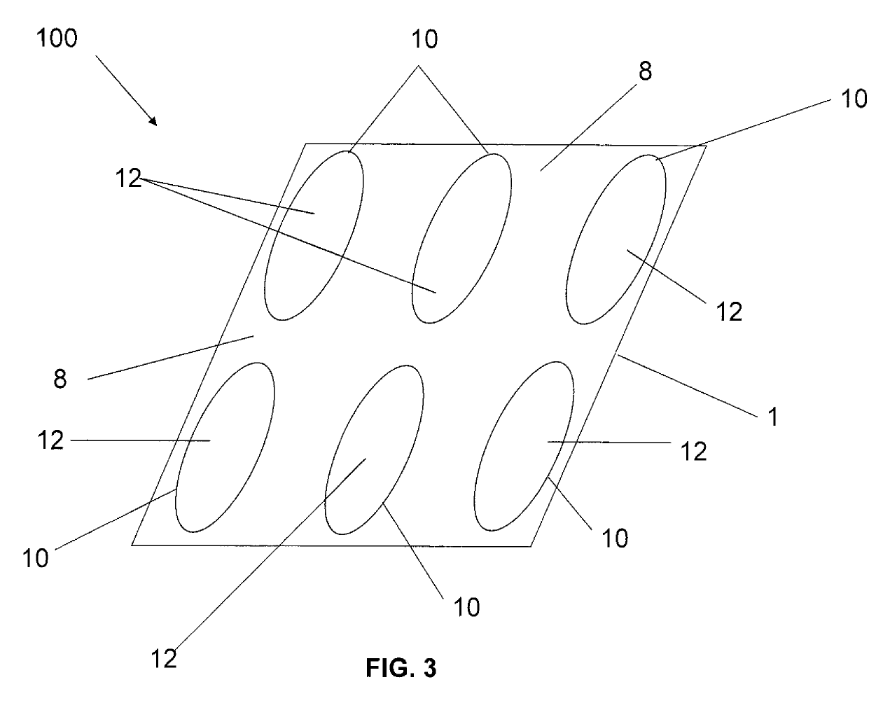

At least one mounting pad, referred to as mounting pads 10, is formed on the bottom surface 8 of the base portion 1 and is provided to reduce the potential for movement or slippage between of the base portion 1 and the surface 3. The mounting pads 10 can be bonded to the base portion 1 using any one of a number of techniques. For example, a pressure sensitive adhesive can be dispensed, rolled or painted between the mounting pads 10 and the bottom surface 8 of the base portion 1. Adhesives can include materials containing cyanoacrylate, epoxy, polyurethane, acrylic resins, and the like. Alternatively, the mounting pads 10 can be formed on the bottom surface 8 of the base portion 1 by jetting, spraying, silk-screening and the like. The techniques and materials for forming the mounting pads 10 to the base portion 1 should not be considered a limitation of the present invention. The mounting pads 10 can be made using a variety of materials including rubber, abrasive particles and a combination of rubber and abrasive particles, and the like. The mounting pads 10 can be patterned as discussed below under FIG. 3. In yet another embodiment, the mounting pads (not shown) includes pins for reducing slippage between the cover 100 and the surface 3 such as a carpet. The pins can be made of materials including plastic, metal and the like. At least one fastener, referred to as fastener 16, is bonded to the top surface 6 of the base portion 1 using techniques known in the art, such as adhesives, thermal bonding, interference fitting, and the like. The fastener 16 can be located along the entire edge 26 or near the edge 26 of the base portion 1. In another embodiment, the fastener 16 can be secured to the base portion 1 at a plurality of locations on the top surface 6. The fastener 16 can be made of materials such as hook or loop fastener material in tape or patch form, and the like.

The detachable layer 18 is flexible and attaches and conforms to the base portion 1. The detachable layer 18 is generally the same size and shape as the base portion 1 and can be made of materials including terry cloth, felt, canvas, synthetic sheep skin, sheep skin, disposable paper material, polyester, chenille, and the like. The detachable layer 18 includes at least one fastener 23 attached to an under surface 22 of the detachable layer 18. The location of the fastener 23 mirrors the fastener 16 location of the base portion 1, because the fasteners 16 and 23 must make contact to engage or connect the base portion 1 to the detachable layer 18. The fastener 23 is provided for receiving the fastener 16 in order to temporarily connect the detachable layer 18 to the base portion 1 of the cover 100. The fastener 23 can be made of fastener material similar to the fastener 16 as mentioned above. The fastener 23 is made of a loop fastener material where the fastener 16 is made of a hook fastener material or visa versa. The fasteners 16 and 23 provide the advantage of quickly connecting and disconnecting the detachable layer 18 from the base portion 1. For example, forces applied in opposite directions to the base portion 1 and the detachable layer 18 can quickly remove (attach) the detachable layer 18 from (to) the base portion 1. Depending on the speed and dexterity of the user, the detachable layer 18 can be quickly removed from the base portion 1 in a time that can range from about 2 seconds to about 5 seconds. The detachable layer 18 provides the advantage of collecting materials such as food, scrap materials and the like. The detachable layer 18 containing the collected material is pulled off from the base portion 1 and the collected material is quickly disposed of in a trash container without picking up and repositioning the base portion 1. Further a detachable layer 18 made of disposable paper can be disposed with any collected food and scrap materials. As mentioned previously, the profile of the cover 100 is maintained, and an upper surface 20 of the detachable layer 18 is smooth in the expanded configuration.

Top 7 and bottom 5 snaps are nested on at least one the fasteners 23 and 16, respectively. In another embodiment the top 7 and bottom 5 snaps can be located at a plurality of locations including opposite corners of the detachable layer 18 and base portion 1, respectively. The top 7 and bottom 5 snaps are used to locate the appropriate portions of the base portion 1 and the detachable layer 18. The top 7 and bottom 5 snaps can be made using metal or plastic snaps, buttons, pins and socket connectors and the like. In another embodiment (not shown), a plurality of top 7 and bottom 5 snaps completely replaces fasteners 16 and 23.

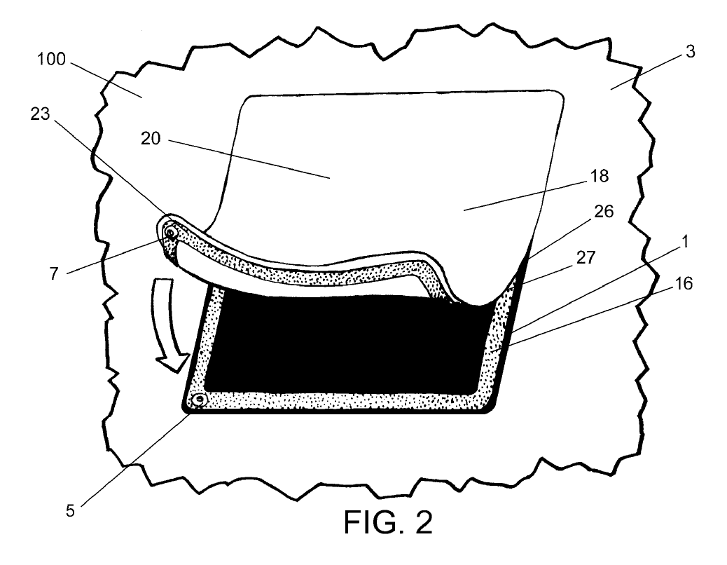

FIG. 2 is a top perspective view of the cover 100 on a surface 3 in the expanded configuration with a portion of the detachable layer 18 detached and folded back. Though shown shaped as a rectangle with rounded corners, the shape of the cover 100 can include a circle, a triangle, an oval, a clover leaf, a heart, a polygon, and the like. For example, the size of a rectangular shaped cover 100 is at least about one foot by about one foot. A design pattern may be included on the upper surface 20 of the detachable layer 18. The edges 26 and 27 of the base portion 1 and detachable layer 18, respectively, are generally in line with each other. The edge 26 of the base portion 1 may extend beyond the edge 27 of the detachable layer 18. This can be due to a combination of workmanship and the positioning of the flexible hoop 4 secured to the base portion 1. The size and shape of the cover 100 should not be considered a limitation of the present invention.

FIG. 3 is a bottom perspective view of rectangular shaped cover 100 including mounting pads 10 secured to the bottom surface 8 of the base portion 1. The shape of the mounting pad 10 can include a circle, a rectangle, a triangle and the like. Further, the shape of the mounting pad 10 can include the outline of an animal, a rainbow, a cartoon figure, a logo, and the like. The arrangement of the mounting pads 10 on the bottom surface can include rows and columns, a series of concentric circles, serpentine, and the like. The bottom of the mounting pad 10 is referred to as a face 12 and provides traction between the cover 100 and the surface 3. In order to provide traction, the face 12 can be made of materials such as rubber. The face 12 can be rough including bumps, pins and the like. Further, the face 12 and the bottom surface 8 can include designs. The shape, design and arrangement of the mounting pads 10 should not be considered limitations of the present invention.

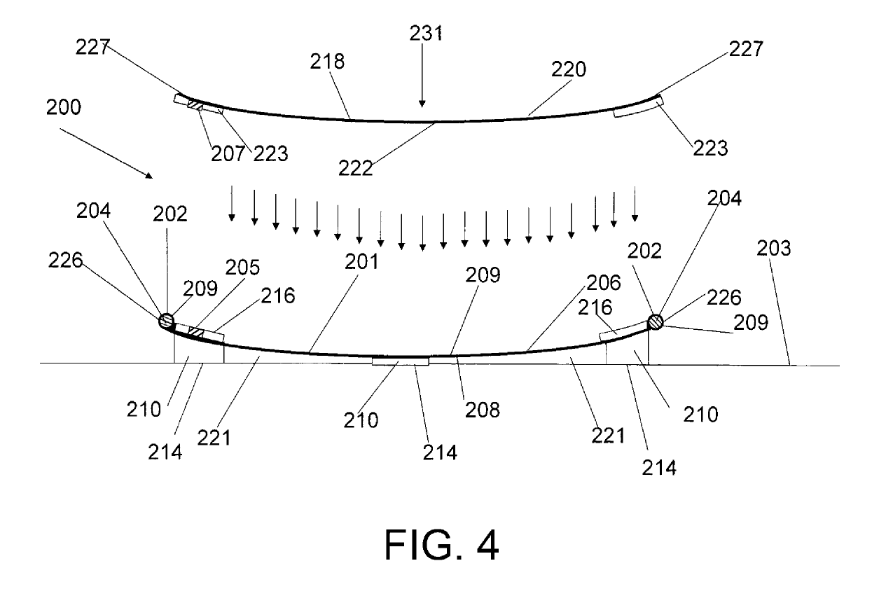

FIG. 4 is an alternate embodiment of the invention showing a cross-sectional view of a cover 200 in an expanded configuration. The cover 200 rests on a generally flat surface 203 and comprises two flexible conforming layers referred to as a base portion 201 and a detachable portion 218. The base portion 201 having top 206 and bottom 208 surfaces comprises a sheet material 209 that further includes a flexible hoop 204. The flexible hoop can be made of materials similar to the materials used to make the flexible hoop 4 of FIG. 1. A sheet material 209 can be secured to the flexible hoop 204 in a manner similar to the methods used to secure the flexible hoop 4 in FIG. 1 including a hem 202. The base portion 201 can include a plurality of layers of sheet material 209. The flexible hoop 204 forces the base portion 201 in a direction extending outward from a center 231 and along the top surface 206. The sheet material 209 is sized shorter than the fully extended flexible hoop 204 and prevents the base portion 201 from fully expanding. As a result, the flexible hoop 204 deflects or bends causing the base portion 201 to form a concave profile. For example, securing the flexible hoop 204 to the base portion 201 to reduce the expansion of the flexible hoop 204 increases the deflection of the flexible hoop 204 and the concavity of the base portion 201. Hence, in fabricating the cover 200, a range of concavities can be established during fabrication by the amount the base portion 201 is allowed to expand with respect to the flexible hoop 204. An under surface 222 of the detachable portion 218 includes fasteners 223 for coupling to the fasteners 216 secured to a top surface 206 of the base portion 201. This allows quick attachment and detachment of the detachable layer 218 from the base portion 201. The orientation of the cover 200 is such that a center 231 is generally the closest point to the surface 203, and the edge 226 is generally furthermost from the surface 203. The profile of the cover 200 with respect to the surface 203 is generally concave or bowl shaped and provides the advantage of better containing liquids contacting an upper surface 220 of the detachable layer 218 of the cover 200 as compared to a generally flat profile. The concavity of the base portion 201 provides a non-uniform space 221 between the base portion 201 and the surface 203. Mounting pads 210 secured to the bottom surface 208 of the base portion 201 can be sized over a range of thicknesses to fill the non-uniform space 221. To fill the non-uniform space, the thicknesses of the mounting pads 210 ranges from about 20 mils to about 125 mils.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A collapsible cover apparatus for protecting a surface, comprising:
a first portion having first and second surfaces;
a spring-like member secured to the first portion to expand or collapse the first portion;
at least one first fastener secured to the first surface; and
a second portion having at least one second fastener for receiving the at least one first fastener, wherein the at least first and second fasteners engage and disengage to enable the first and second portions to quickly attach and detach, respectively.

2. The collapsible cover apparatus of claim 1, further comprises at least one mounting pad secured to the second surface for resting the first portion on the surface.

3. The collapsible cover apparatus of claim 2, wherein the first portion includes at least one sheet of a flexible material.

4. The collapsible cover apparatus of claim 3, wherein the second portion comprises a fourth surface.

5. The collapsible cover apparatus of claim 4 further comprising at least one first and second locator respectively secured on the first and fourth surfaces.

6. The collapsible cover apparatus of claim 5, wherein the at least one first and second locators are nested on the at least one first and second fasteners, respectively.

7. The collapsible cover apparatus of claim 6, wherein the first and second locators engage to orient the first and second portions for attaching the second portion to the first portion.

8. The collapsible cover apparatus of claim 7, wherein the first and second locators engage to allow quick attachment of the first and second portions and disengage for quick detachment of the first and second portions.

9. The collapsible cover apparatus of claim 8 wherein the profile of the first and second portions conform to generally the same profile when the second portion is attached to the first portion and the spring-like member has expanded the first portion.

10. The collapsible cover apparatus of claim 9, wherein the profile of the cover ranges from generally parallel to generally concave with respect to the surface when the spring-like member has expanded the cover.

11. The collapsible cover apparatus of claim 10, wherein any gap between the first portion and the surface resulting from any concavity of the cover with respect to the surface is filled by the at least one mounting pad.

12. The collapsible cover apparatus of claim 11, wherein the shape of the first and second portions includes a circle, a rectangle, a triangle, an oval, clover leaf, a heart, and a polygon.

13. The collapsible cover apparatus of claim 13, wherein the at least one mounting pad comprises a bottom face for gripping the surface.

14. The collapsible cover apparatus of claim 14, wherein the bottom face of the at least one mounting pad comprises a material selected from the group of materials consisting of-rubber, plastic and abrasive particles.

15. A collapsible cover apparatus for protecting a surface, comprising:
a first portion having first and second surfaces;
a spring-like member secured to the first portion to expand or collapse the first portion;
a second portion having third and fourth surfaces; and
at least one first and second fastener secured to the respective first and fourth surfaces of the first and second portions, respectively, wherein the at least one first and second fastener engages to allow quick attachment or detachment between the first and second portions.

16. The collapsible cover apparatus of claim 15, wherein the first portion comprises a hem for securing the spring-like member.

17. The collapsible cover apparatus of claim 16, further comprising at least one mounting pad having a bottom facing the surface, the at least one mounting pad secured to the second surface.

18. The collapsible cover apparatus of claim 17, wherein the third surface comprise a decorative design.

19. The collapsible cover apparatus of claim 18, wherein the second surface and the bottom of the at least one mounting pad comprise a decorative design.
